(19) United States
(12) Patent Application Publication
(10) Pub. No.: US 2025/0297500 A1
(43) Pub. Date: Sep. 25, 2025

(54) Device for Fully Electrical Opening of a Vehicle Flap

(71) Applicant: Bayerische Motoren Werke Aktiengesellschaft, Muenchen (DE)

(72) Inventor: Holger DIEHL, Muenchen (DE)

(21) Appl. No.: 18/293,009

(22) PCT Filed: Jul. 26, 2022
(86) PCT No.: PCT/EP2022/070937

§ 371 Date: Jul. 9, 2024

(30) Foreign Application Priority Data
Jul. 30, 2021 (DE) 10 2021 119 876.3

(51) Int. Cl. E05B 81/56; E05B 77/54; E05B 81/04; E05B 81/70

(52) U.S. Cl. CPC E05B 81/56; E05B 77/54; E05B 81/04; E05B 81/70

(57) ABSTRACT

A device (200) for controlling a lock (102) of a vehicle flap (105) is described. The device (200) comprises an operating element (106) which can be actuated by a user in order to close a circuit and to thereby cause the lock (102) of the vehicle flap (105) to open. The device (200) further comprises a disconnector (204) which is designed to prevent closing of the circuit by the operating element (106) when a vehicle door (108) of the vehicle (100) is closed, and to allow closing of the circuit by the operating element (106) when the vehicle door (108) of the vehicle (100) is open.

### BACKGROUND AND SUMMARY

The invention relates to a device for fully electric opening of a vehicle flap, in particular a front flap of a vehicle.

A two-track vehicle typically has a front flap (also referred to as a front hood) in the front area of the vehicle, in front of the passenger compartment of the vehicle, which covers a front space of the vehicle, in which, for example, the drive motor of the vehicle can be arranged and/or which can be designed as a baggage compartment.

A lever can be arranged in the passenger compartment, which can be actuated by a vehicle occupant to open the front flap. By actuating the lever, the front flap can be mechanically transferred from an engaged position into a pre-engaged position. The front flap is then typically still held back by a catch hook, which can be moved manually by the user of the vehicle to open the front flap. It is thus possible to reliably prevent the front flap from opening during the journey of the vehicle and blocking the view of the driver of the vehicle in this case.

In particular in an electrically driven vehicle, the front space of the vehicle can be used as a baggage compartment, which has the result that the front flap is opened and/or closed relatively frequently by a user. The present document relates to the technical object of enabling convenient opening of a vehicle flap, in particular a front flap, of a vehicle in a safe manner (in particular according to ASIL-D).

The object is achieved by the independent claim. Advantageous embodiments are described, inter alia, in the dependent claims. It is to be noted that additional features of a claim dependent on an independent claim, without the features of the independent claim or in combination with only a subset of the features of the independent claim, can form a separate invention independent of the combination of all features of the independent claim, which can be made the subject matter of an independent claim, a divisional application, or a subsequent application. This applies in the same manner to technical teachings described in the description, which can form an invention independent of the features of the independent claims.

According to one aspect, a device is described for controlling a lock of a vehicle flap. The vehicle flap can be a front flap (in particular a motor hood) of the vehicle, which is arranged in front of the passenger compartment of the vehicle. The lock of the vehicle flap can have a catch mechanism, by which a bolt of the lock is engaged in order to transfer the vehicle flap from a pre-engaged position into an engaged position. Furthermore, the lock can have a pre-engagement actuator (such as an electric motor), which is designed to transfer the bolt of the lock automatically from the engaged position into the pre-engaged position.

Furthermore, the lock can have a catch hook, which is designed to hold the vehicle flap in the pre-engaged position and to prevent further opening of the vehicle flap. In addition, the lock can have a catch hook actuator (such as an electric motor), which is designed to move the catch hook in order to enable the further (complete) opening of the vehicle flap.

The device comprises an operating element (such as a button), which can be actuated by a user to close a circuit. The operating element can be actuated by the user to cause the lock of the vehicle flap to be (automatically) opened. The operating element can be arranged in the passenger compartment of the vehicle. The operating element can be provided so that in reaction to the actuation of the operating element, the lock of the vehicle flap is automatically opened (by the pre-engagement actuator and by the catch hook actuator) and the vehicle flap is possibly completely opened.

The actuation of the operating element can be indicated to a control module of the device by closing the circuit. The operating element can comprise a switching element for this purpose, which is closed upon actuation of the operating element to close the circuit. The circuit can be connected to the control module, in particular to a port of the control module, of the device.

The device furthermore comprises a disconnecting switch. The disconnecting switch can be designed, for example, as a mechanical switch, as a semiconductor-based switch, and/or as a relay. The disconnecting switch is designed to prevent closing of the circuit by the operating element if (at least) one vehicle door (such as the driver door) of the vehicle is closed and/or if all vehicle doors of the vehicle are closed. Furthermore, the disconnecting switch can be designed to enable closing of the circuit by the operating element if the vehicle door (such as the driver door) of the vehicle (or at least one vehicle door of the vehicle) is open.

The disconnecting switch can be arranged inside the circuit. The disconnecting switch can then in the open state have the effect that the circuit cannot be closed (even by actuating the operating element). On the other hand, in the closed state the disconnecting switch can have the effect that the circuit can be closed by actuating the operating element.

The device can therefore be designed (for example, according to ASIL-B) to check whether the vehicle door (in particular the driver door) is open or closed. Furthermore, the device can be designed (for example, according to ASIL-B) to detect the actuation of the operating element. Automatic opening of the lock of the vehicle flap can possibly only be enabled or caused if both the open vehicle door and the actuation of the operating element are detected. Automatic opening of the vehicle flap can thus be caused with a high level of functional safety (for example, according to ASIL-D).

The disconnecting switch can be designed to be actuated, in particular opened or closed, (directly) by the vehicle door (for example by a mechanical switch which is arranged directly on the vehicle door). The actuation of the disconnecting switch can take place in particular such that the disconnecting switch is opened and thus prevents the closing of the circuit when the vehicle door is closed; and/or that the disconnecting switch is closed and thus enables the closing of the circuit when the vehicle door is open. The disconnecting switch can therefore possibly be installed directly in the vehicle door, for example in the frame of the vehicle door. Automatic opening of the vehicle flap can thus be enabled with a particularly high level of functional safety.

Alternatively or additionally, the control module of the device can be configured to open the disconnecting switch as a function of sensor data of a (separate) door contact sensor of the vehicle door in order to prevent the closing of the circuit, or to close it to enable the closing of the circuit. Automatic and safe opening of the vehicle flap can thus be enabled in a particularly efficient manner.

The control module can be designed to check whether the circuit is closed or is interrupted. At least one actuator of the lock can then be prompted to open the lock of the vehicle flap if, in particular only if, it is determined that the circuit is closed. Safe and reliable opening of the vehicle flap can thus be enabled.

The control module can be configured (in particular by means of a speed sensor of the vehicle) to determine speed information with respect to the vehicle speed of the vehicle. The at least one actuator of the lock can then be prompted as a function of the speed information to open the lock of the vehicle flap. The control module can be configured in particular to check on the basis of the speed information whether the travel speed of the vehicle is less than or equal to a speed threshold value (for example, 0 km/h or between 0 km/h and 5 km/h). Furthermore, the control module can be configured to prompt the at least one actuator to open the lock of the vehicle flap if, in particular only if, it is determined that the travel speed of the vehicle is less than or equal to the speed threshold value. The functional safety in the automatic opening of the vehicle flap can be further increased by the additional consideration of the travel speed of the vehicle.

As already described above, the lock can comprise a catch hook actuator for the catch hook of the lock for holding back the vehicle flap and/or a pre-engagement actuator for disengaging the locking bolt. The control module can be designed to activate precisely one actuator from the actuator set which comprises the catch hook actuator and the pre-engagement actuator (or which consists of these two actuators) if it is determined that the circuit is closed.

Furthermore, the control module can be configured to determine (separately) on the basis of the sensor data of the door contact sensor whether the vehicle door is open or closed. The other actuator from the actuator set can then be activated in a complementary manner when it is determined that the vehicle door is open.

It can thus be determined in different ways whether the vehicle door is open or closed. Furthermore, the two actuators of the lock can be activated or not activated separately as a function of the respective determined state of the vehicle door. The functional safety for the automatic opening of the vehicle flap can thus be further increased.

The device can comprise a catch hook control module for controlling the catch hook actuator and a separate pre-engagement control module for controlling the pre-engagement actuator. The functional safety of the device can thus be further increased.

According to a further aspect, a (road) motor vehicle (in particular a passenger vehicle or a truck or a bus) is described, which can have the device described in this document.

The vehicle typically comprises a vehicle door, which is arranged in a door frame of the vehicle and is designed to be transferred from the closed state to the open state in order to enable access to the passenger compartment of the vehicle for a user of the vehicle.

Furthermore, the vehicle comprises a vehicle flap having an electrically actuatable lock. The vehicle flap can be designed in particular (by opening the lock) to be automatically opened (for example, such that the flap is automatically moved out of the frame of the flap). As already described above, the vehicle flap can be a front flap of the vehicle which is arranged in front of the passenger compartment of the vehicle.

The vehicle can furthermore comprise an operating element (such as a switch or button), which is designed to be actuated by the user in order to cause the lock of the vehicle flap to be automatically opened. The operating element can be designed to close a circuit, in particular a circuit for the power supply of the lock, in reaction to an actuation of the operating element.

The operating element can be arranged on the door frame of the vehicle such that the operating element can be actuated by the user (and is accessible to the user for this purpose) when the vehicle door is in the open state, and such that the operating element cannot be actuated by the user (and in particular is not accessible to the user) when the vehicle door is in the closed state. Safe automatic opening of the vehicle flap can thus be enabled in a particularly efficient manner.

The door frame typically has an inner surface facing toward the vehicle door. In one preferred example, the operating element is arranged on the inner surface of the door frame (so that it is not accessible to the user in the closed state of the vehicle door). It can thus be effectuated in a particularly reliable manner that the operating element can only be actuated when the vehicle door is open.

It is to be noted that the devices and systems described in this document can be used both alone and in combination with other devices and systems described in this document. Furthermore, any aspects of the devices and systems described in this document can be combined with one another in a variety of ways. In particular, the features of the claims can be combined with one another in a variety of ways.

The invention is described in more detail hereinafter on the basis of exemplary embodiments.

### BRIEF DESCRIPTION OF THE DRAWINGS

FIG. 1 shows an exemplary vehicle having a front flap as an example of a general vehicle flap;

FIGS. 2a and 2b show different states of an exemplary device for controlling the lock of a vehicle flap; and

FIG. 3 shows an exemplary door frame having an operating element.

### DETAILED DESCRIPTION OF THE DRAWINGS

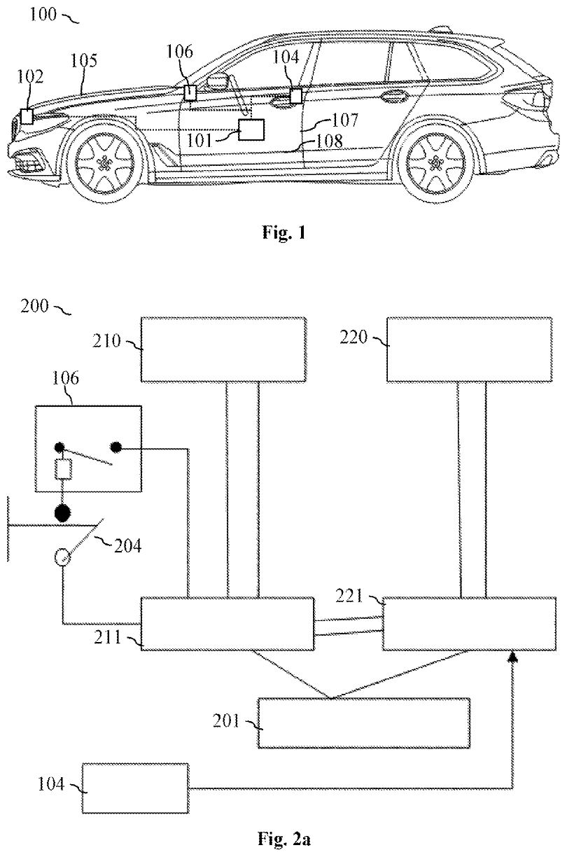

As described at the outset, the present document relates to opening a vehicle flap in a convenient and safe manner. In this context, FIG. 1 shows exemplary components of a vehicle 100 having a front flap 105 as an example of a vehicle flap. The vehicle 100 comprises a lock 102, using which the vehicle flap 105 can be locked. The lock 102 can have an engaged position, in which the vehicle flap 105 is completely closed. Furthermore, the lock 102 can have a pre-engaged position, in which the vehicle flap 105 is disengaged, but is still held back by a catch hook. The vehicle flap 105 can possibly be transferred by a pre-engagement actuator from the pre-engaged position into the engaged position (or vice versa). Furthermore, the vehicle 100 can have a catch hook actuator, by which the catch hook is actuated to completely release the vehicle flap 105. The one or more actuators can be controlled via a control module 101 of the vehicle 100.

The vehicle 100 can furthermore have an operating element 106 (for example, in the interior or in the passenger compartment of the vehicle 100), which can be actuated by a user to open the vehicle flap 105. Furthermore, the vehicle 100 can have a door contact sensor 104, via which it can be detected whether a door of the vehicle 100 (for example, the driver door or the front passenger door) is open or closed.

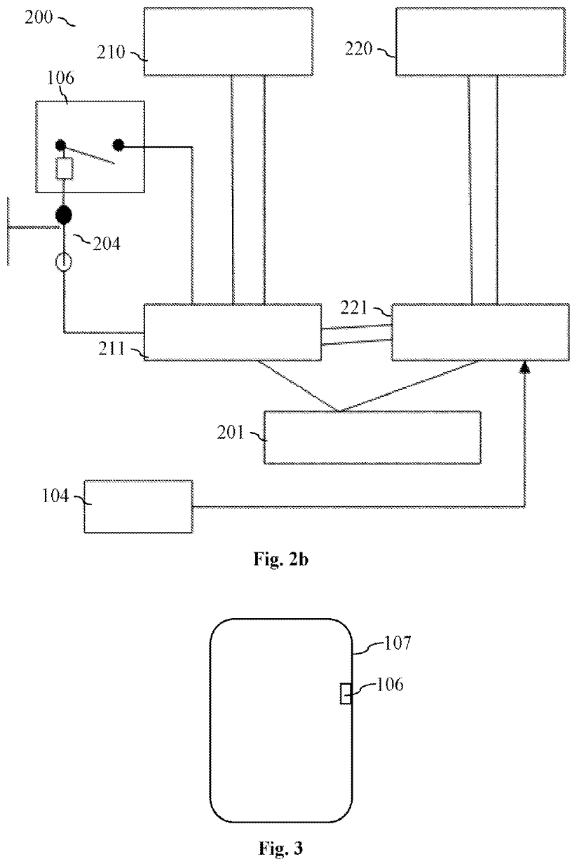

FIGS. 2a and 2b show different states of a device 200 for opening a vehicle flap 105. The device 200 is configured in particular to activate the pre-engagement actuator 220 and the catch hook actuator 210 of the lock 102 of the vehicle flap 105 to enable safe and convenient opening of the vehicle flap 105.

The device 200 comprises a catch hook control module 211, which is configured to control the catch hook actuator 210 and to control a pre-engagement control module 221, which is designed to control the pre-engagement actuator 220. The pre-engagement control module 221 can be designed to determine status information with respect to the status of the vehicle 100. The status information can comprise in particular status information with respect to one or more vehicle doors (which can be provided by a door contact sensor 104). The status information can indicate whether at least one vehicle door is open; and/or status information with respect to the vehicle speed (which can be provided, for example, by a speed sensor 201 of the vehicle 100).

The pre-engagement control module 221 can be designed to check on the basis of the status information whether the pre-engagement actuator 220 can be operated to transfer the vehicle flap 105 automatically from the engaged position into the pre-engaged position.

The device 200 comprises a disconnecting switch 204, which is designed to be opened or closed depending on the status of the one or more doors of the vehicle 100. In particular, the disconnecting switch 204 can be opened (as shown in FIG. 2a) when all doors of the vehicle 100 are closed. On the other hand, the disconnecting switch 204 can be closed (as shown in FIG. 2b) when at least one door (in particular the driver door) of the vehicle 100 is open.

As described above, the vehicle 100 has an operating element 106 (such as a button), which can be actuated by an occupant of the vehicle 100 to cause automatic opening of the vehicle flap 105. For example, actuating the operating element 106 can cause a circuit to be closed. The disconnecting switch 204 can be arranged within this circuit (in series to the operating element 106), so that it is only possible to close the circuit by actuating the operating element 106 when the disconnecting switch 204 is closed.

The disconnecting switch 204 can therefore be designed so that an actuation of the operating element 106 can only be detected by a control module 211, 221 of the device 200 when the disconnecting switch 204 is closed (and therefore at least one door (in particular the driver door) of the vehicle 100 is open).

The catch hook control module 211 can be designed to activate the catch hook actuator 210 in order to release the catch hook when an actuation of the operating element 106 is detected. Actuation of the operating element 106 can possibly only be detected, however, when the disconnecting switch 204 is closed (and thus at least one door of the vehicle 100 is open). Furthermore, the status information with respect to the travel speed of the vehicle 100 can possibly be taken into consideration. It is thus possible to reliably prevent the vehicle flap 105 from being automatically opened during the journey of the vehicle 100.

A device 200 is therefore described which enables fully electric opening of the front flap 105 of a vehicle 100 (without the catch hook having to be released manually by the user of the vehicle 100). The device 200 preferably meets ASIL-D requirements here with respect to the functional safety in order to prevent inadvertent opening during the journey of the vehicle 100 (while the operating element 106 typically only meets ASIL-B requirements).

The device 200 is designed such that the operating element 106 (such as a switch or a button) for opening the front flap 105 is only operable when the driver door is open. This can be effectuated, for example, by a microswitch 204 which only closes the circuit for the button 106 when the door is far enough open. Alternatively or additionally, this can be effectuated by a switch in the control device 101, 211, 221, which inputs the sensor data of an ASIL-B door contact sensor 104. The switch in the control device 101, 211, 221 can energize the operating button 106 when the door contact sensor 104 reports an open door. On the other hand, the switch can be opened (to prevent the power supply of the operating button 106), for example, according to ASIL-B, when the door contact is closed and/or when the speed signal with respect to the vehicle speed exceeds a predefined limiting value.

A disconnecting switch 204 can therefore be integrated in the power supply of the operating element 106 for opening the front flap 105. The positions of the disconnecting switch 204 (closed/open) can be permanently coupled with the door position (of the driver door). In the state “door open”, the disconnecting switch 204 is closed, so that the circuit is closed by pressing the operating element 106 and therefore the operating intention is transmitted to the inputting control device 211. In the state “door closed”, the disconnecting switch 204 is open, so that an operating intention cannot be transmitted via the operating element 106, since the circuit is not closed even upon actuation of the operating element 106.

A microswitch in the door frame of the vehicle door can be used as an embodiment of the disconnecting switch 204. Alternatively or additionally, a semiconductor-based disconnecting switch and/or a relay (each designed according to ASIL-B) can be integrated in the control device 101, 211, 221, which the operating element 106 inputs and supplies with voltage for this purpose. The disconnecting switch 204 in the control device 101, 211, 221 can then be coupled with the status of the door contact sensor 104 (which meets ASIL-B requirements). When the door contact sensor 104 indicates “door open”, the operating element 106 is energized by closing the disconnecting switch 204, so that the user can close the circuit by actuating the operating element 160 to cause the vehicle flap 105 to be opened.

As already described above, the automatic opening of a vehicle flap 105 is to be enabled with a high level of functional safety by the measures described in this document. It is to be ensured in particular that the automatic opening of the vehicle flap 105 in reaction to the actuation of the operating element 106 is only possible if at least one vehicle door, in particular the driver door, is open. FIG. 1 shows an exemplary vehicle door 108, in particular the driver door, which is arranged in a door frame 107. The door frame 107 is typically part of the body of the vehicle 100. The door frame 107, in particular the inner surface of the door frame 107 facing toward the vehicle door 108, is typically only accessible to the user of the vehicle 100 when the vehicle door 108 is open.

FIG. 3 illustrates a door frame 107 for a vehicle door 108 on which the operating element 106 for opening the vehicle flap 105 is arranged (in particular on the inner surface of the door frame 107). The operating element 106 is designed in particular such that the operating element 106 is not accessible to the user when the vehicle door 108 is closed. In other words, the operating element 106 is arranged on the door frame 107 such that the operating element 106 cannot be actuated by the user of the vehicle 100 when the vehicle door 108 is closed (and thus covers the operating element 106).

Due to such an arrangement of the operating element 106 (even without additional disconnecting switch 204), it can be effectuated with a high level of functional safety that the vehicle flap 105 is only automatically opened when at least one vehicle door 108, in particular the driver door, is open.

The automatic opening of a vehicle flap 105 can be enabled with a high level of functional safety by the measures described in this document.

The present invention is not restricted to the exemplary embodiments shown. In particular, it is to be noted that the description and the figures are only to illustrate the principle of the proposed devices and systems by way of example.

1.-14. (canceled)

15. An apparatus for controlling a lock of a vehicle flap of a vehicle, the apparatus comprising:
an operating element configured to be actuated by a user to close a circuit and to cause the lock of the vehicle flap to be opened; and
a disconnecting switch configured to
prevent closing of the circuit by the operating element when a vehicle door of the vehicle is closed; and
enable closing of the circuit by the operating element when the vehicle door of the vehicle is open.

16. The apparatus according to claim 15, wherein the disconnecting switch is configured to be opened and closed by the vehicle door such that:
the disconnecting switch is open, and thus prevents the closing of the circuit, when the vehicle door is closed; and
the disconnecting switch is closed, and thus prevents the closing of the circuit, when the vehicle door is open.

17. The apparatus according to claim 15, further comprising a control module configured to open the disconnecting switch depending on sensor data of a door contact sensor of the vehicle door to prevent the closing of the circuit or to close the disconnecting switch to enable the closing of the circuit.

18. The apparatus according to claim 16, further comprising a control module configured to open the disconnecting switch depending on sensor data of a door contact sensor of the vehicle door to prevent the closing of the circuit or to close the disconnecting switch to enable the closing of the circuit.

19. The apparatus according to claim 15, further comprising a control module configured to:
determine whether the circuit is closed or is interrupted; and
prompt at least one actuator to open the lock of the vehicle flap only in a case in which the circuit is determined to be closed.

20. The apparatus according to claim 16, further comprising a control module configured to:
determine whether the circuit is closed or is interrupted; and
prompt at least one actuator to open the lock of the vehicle flap only in a case in which the circuit is determined to be closed.

21. The apparatus according to claim 19, wherein the control module is configured to:
determine, based on a speed sensor of the vehicle, speed information with respect to a travel speed of the vehicle; and
prompt the at least one actuator depending on the speed information to open the lock of the vehicle flap.

22. The apparatus according to claim 21, wherein the control module is configured to:
determine, based on the speed information, whether the travel speed of the vehicle is less than or equal to a speed threshold value; and
prompt the at least one actuator to open the lock of the vehicle flap only in a case in which the travel speed of the vehicle is determined to be less than or equal to the speed threshold value.

23. The apparatus according to claim 19, wherein
the lock comprises a catch hook actuator for a catch hook of the lock for holding back the vehicle flap and a pre-engagement actuator for disengaging a locking bolt; and
the control module is designed to actuate precisely one actuator from an actuator set that comprises the catch hook actuator and the pre-engagement actuator in a case in which the circuit is closed.

24. The apparatus according to claim 20, wherein
the lock comprises a catch hook actuator for a catch hook of the lock for holding back the vehicle flap and a pre-engagement actuator for disengaging a locking bolt; and
the control module is designed to actuate precisely one actuator from an actuator set that comprises the catch hook actuator and the pre-engagement actuator in a case in which the circuit is closed.

25. The apparatus according to claim 21, wherein
the lock comprises a catch hook actuator for a catch hook of the lock for holding back the vehicle flap and a pre-engagement actuator for disengaging a locking bolt; and
the control module is designed to actuate precisely one actuator from an actuator set that comprises the catch hook actuator and the pre-engagement actuator in a case in which the circuit is closed.

26. The apparatus according to claim 23, wherein the control module is configured to:
determine sensor data of a door contact sensor of the vehicle door;
determine, based on the sensor data, whether the vehicle door is open or closed; and
actuate in a complementary manner a second actuator from the actuator set, which comprises the catch hook actuator and the pre-engagement actuator, in a case in which the vehicle door is open.

27. The apparatus according to claim 23, wherein the apparatus comprises a catch hook control module for controlling the catch hook actuator and a separate pre-engagement control module for controlling the pre-engagement actuator.

28. The apparatus according to claim 26, wherein the apparatus comprises a catch hook control module for controlling the catch hook actuator and a separate pre-engagement control module for controlling the pre-engagement actuator.

29. A vehicle comprising:
a vehicle door, which is arranged in a door frame of the vehicle and is configured to be transferred from a closed state into an open state in order to enable access to a passenger compartment of the vehicle for a user of the vehicle;
a vehicle flap having an electrically actuatable lock; and
an operating element, which is configured to be actuated by the user to cause the lock of the vehicle flap to be automatically opened;
wherein the operating element is arranged on the door frame of the vehicle such that
the operating element is actuatable by the user when the vehicle door is in the open state; and
the operating element cannot be actuated by the user when the vehicle door is in the closed state.

30. The vehicle according to claim 29, wherein the vehicle flap is a front flap of the vehicle, which is arranged in front of the passenger compartment of the vehicle.

31. The vehicle according to claim 29, wherein the operating element is designed to close a circuit for the power supply of the lock in reaction to an actuation of the operating element.

32. The vehicle according to claim 29, wherein
the door frame has an inner surface facing toward the vehicle door; and
the operating element is arranged on the inner surface.

33. The vehicle according to claim 29, wherein the vehicle comprises an apparatus for controlling a lock of a vehicle flap of a vehicle, the apparatus including:
an operating element configured to be actuated by a user to close a circuit and to cause the lock of the vehicle flap to be opened; and
a disconnecting switch configured to
prevent closing of the circuit by the operating element when a vehicle door of the vehicle is closed; and
enable closing of the circuit by the operating element when the vehicle door of the vehicle is open.
